(19) United States
(12) Patent Application Publication
(10) Pub. No.: US 2010/0141976 A1
(43) Pub. Date: Jun. 10, 2010

(54) INFORMATION PROCESSING APPARATUS, INFORMATION PROCESSING METHOD, AND STORAGE MEDIUM

(75) Inventor: Seiji Ohmori, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/625,405

(22) Filed: Nov. 24, 2009

(30) Foreign Application Priority Data
Dec. 5, 2008 (JP) 2008-311295

(51) Int. Cl. G06K 15/02

(52) U.S. Cl. 358/1.13; 358/1.18

(57) ABSTRACT

An information processing apparatus includes a determination unit configured to determine whether structured data including layout information and image information is in a predetermined format, and a rendering unit configured to perform rendering of the image information without using the layout information when the determination unit determines that the structured data is in the predetermined format, and to perform rendering of the image information using the layout information when the determination unit determines that the structured data is not in the predetermined format.

### BACKGROUND OF THE INVENTION

1. Field of the Invention

The present invention relates to a technique of rendering structured data.

2. Description of the Related Art

In recent years, cases in which information used for displaying or printing is expressed by structured data, such as Extensible Markup Language (XML), are increased. For example, cases in which an application for personal computers (PCs) which can display and edit an office document employs XML format as a file format of an office document are increased.

In the Word Wide Web (WWW), structured documents such as Hypertext Markup Language (HTML) or scalable vector graphics (SVG) are widely being used. In the case of using image data such as a photograph in structured data, a method of writing link information to image data in structured data is commonly being used.

A conventional apparatus can perform displaying or printing of structured data. In this apparatus, after structured data is analyzed, rendering is performed to generate rendering data used for displaying or printing. There are display apparatuses or printing apparatuses which can deal with various types of structured data. In these apparatuses, as a method of reducing a rendering time, there is a method of storing image data, as a rendering result, obtained by analyzing structured data in the apparatus (Japanese Patent Application Laid-Open Nos. 2002-278719 and 2004-266470).

However, in a processing module which performs analysis processing of structured data, as a specification of structured data is complicated, the size of the processing module itself is increased, and a required processing time is also increased.

Structured data of various formats are being distributed in the world, but there is a problem in that to cope with structured data of many types, the size of the processing module itself is increased as much. In particular, in an apparatus in which a storage area such as a read only memory (ROM) or a random access memory (RAM) is small or an apparatus in which the processing ability of a central processing unit (CPU) is not enough, the problems in the processing time or the size of the processing module are remarkable.

### SUMMARY OF THE INVENTION

The present invention is directed to an information processing apparatus capable of reducing the processing time and the size of a processing module for performing rendering processing of data.

According to an aspect of the present invention, an information processing apparatus includes a determination unit configured to determine whether structured data including layout information and image information is in a predetermined format, and a rendering unit configured to perform rendering of the image information without using the layout information when the determination unit determines that the structured data is in the predetermined format, and to perform rendering of the image information using the layout information when the determination unit determines that the structured data is not in the predetermined format.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a view illustrating a configuration of a printer device according to an exemplary embodiment of the invention.

FIG. 2 is a configuration view illustrating a concept of a system including a printer device according to an exemplary embodiment of the invention.

FIG. 3 is a view illustrating an example of a document transmitted from a computer device or a scanner device to a printer device.

FIG. 4 is a view illustrating a rendering configuration of a document illustrated in FIG. 3.

FIG. 5 is a view illustrating a configuration of an archive file which is in a storage format of a document used in an exemplary embodiment of the invention.

FIG. 6 is a view illustrating a configuration of data included in a content section illustrated in FIG. 5.

FIG. 7 is a flowchart illustrating a flow of processing for printing an archive file, in which a configuration illustrated in FIG. 6 is included in a content section, using a printer device of a comparative example.

FIG. 8 is a view illustrating a rendering configuration of a document illustrated in FIG. 3.

FIG. 9 is a view illustrating a configuration of data included in a content section of an archive file of a document having a configuration illustrated in FIG. 8.

FIG. 10 is a flowchart illustrating a flow of processing for printing an archive file using a printer device according to a first exemplary embodiment of the invention.

FIG. 11 is a view illustrating a rendering configuration of a document illustrated in FIG. 3 used in a second exemplary embodiment of the invention.

FIG. 12 is a view illustrating a configuration of data included in a content section of an archive file of a document having a configuration illustrated in FIG. 11.

FIG. 13 is a flowchart illustrating a flow of processing for printing an archive file using a printer device according to the second exemplary embodiment of the invention.

### DESCRIPTION OF THE EMBODIMENTS

Various exemplary embodiments, features, and aspects of the invention will be described in detail below with reference to the drawings.

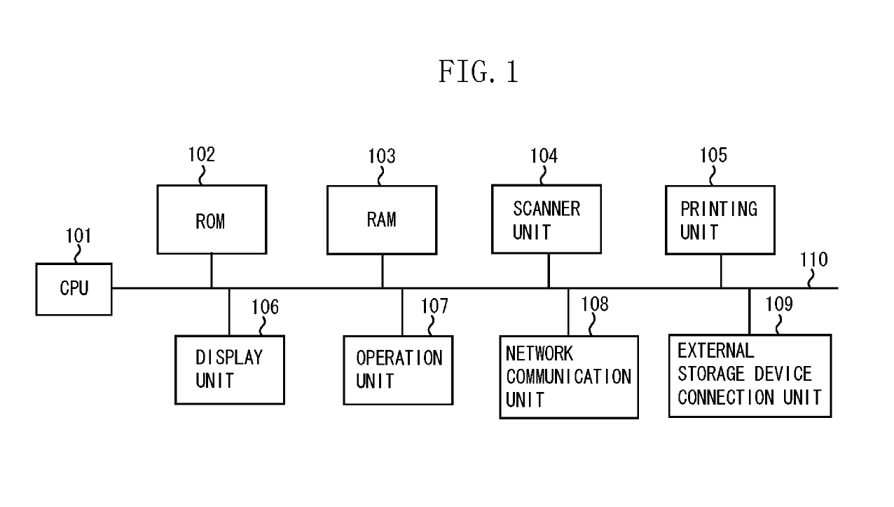

FIG. 1 is a view illustrating a configuration of a printer device according to a first exemplary embodiment of the invention.

In FIG. 1, a CPU 101 is a system controller and controls the whole device. A ROM 102 is a read only memory for storing a control program of the CPU 101 or various types of fixed data. The RAM 103 is a rewritable memory including a static random access memory (SRAM) or a dynamic random access memory (DRAM) and stores program control variables. Various setting parameters and various work buffers are also stored in the RAM 103.

A scanner unit 104 optically reads a print to generate rendering data. The printing unit 105 prints image data on a recording paper using an ink jet technique. A display unit 106 provides a display to view by an operator, using a liquid crystal display (LCD) or a light emitting diode (LED). An operation unit 107 includes a hard button or a pointing device, and the operator can perform various input operations via the operation unit 107.

A network communication unit 108 is connected to a local area network (LAN) and performs various communications such as reception of print data. A memory card in which document data is stored can be inserted into an external storage device connection unit 109. The external storage device connection unit 109 reads various data from the inserted memory card. A plurality of memory cards may be inserted into the external storage device connection unit 109. A system bus 110 connects the respective units 101 to 109 to be communicated with each other.

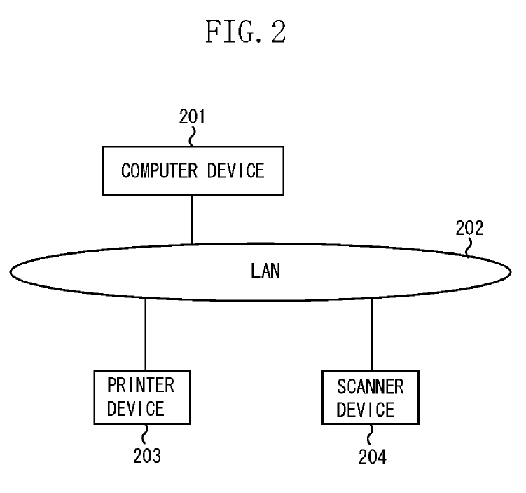

FIG. 2 is a configuration view illustrating a concept of a system including a printer device according to the first exemplary embodiment of the invention.

As illustrated in FIG. 2, a computer device 201, a printer device 203, and a scanner device 204 are connected to a LAN 202 and may communicate with each other. In FIG. 2, devices such as the computer device 201, the printer device 203, and the scanner 204 are connected to the LAN 202, but other devices may be connected to the LAN 202.

In the present exemplary embodiment, a case in which an archive file transmitted from the computer device 201 or the scanner device 204 to the printer device 203 is printed by the printer device 203 is described as an example. The printer device 203 is a configuration as an application example of the information processing apparatus of the present invention.

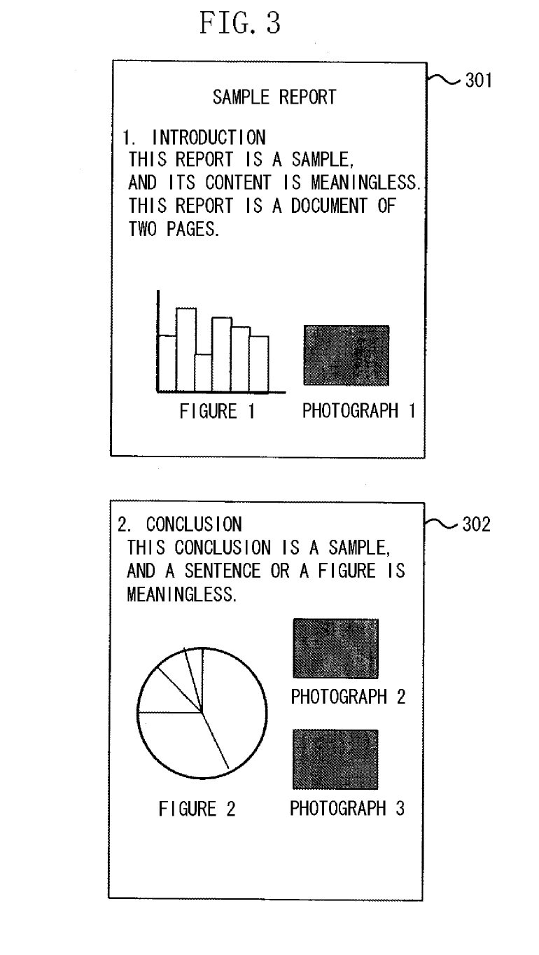

FIG. 3 is a view illustrating an example of a document stored as an archive file transmitted from the computer device 201 or the scanner device 204 to the printer device 203. As illustrated in FIG. 3, in the present exemplary embodiment, a case of printing a document of two pages (the first page 301 and the second page 302) is described as an example. In FIG. 3 and subsequent figures, photograph portions are colored in black for convenience.

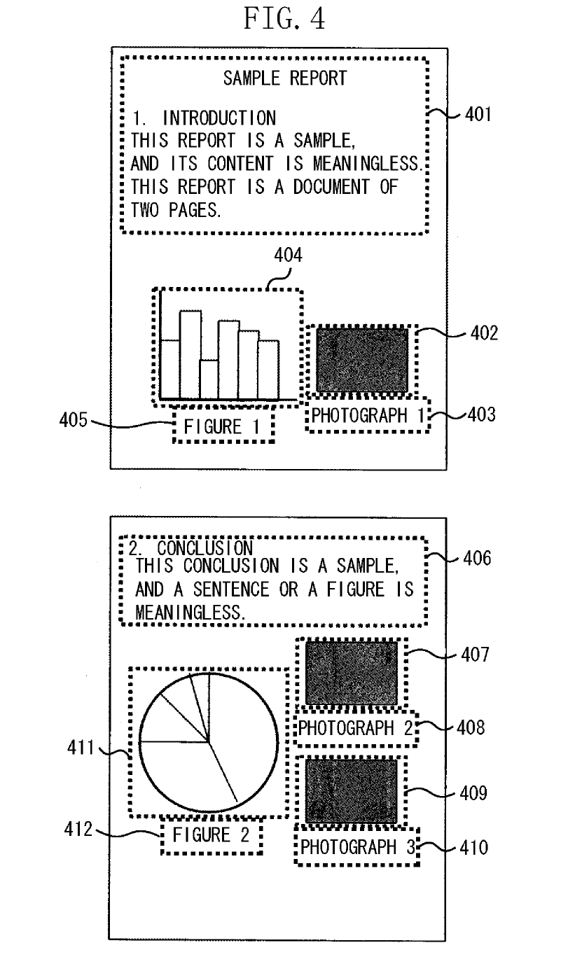

FIG. 4 is a view illustrating a rendering configuration of a document illustrated in FIG. 3. The documents illustrated in FIGS. 3 and 4 include text data, image data, and graphic data. Portions surrounded by dotted lines 401, 403, 405, 406, 408, 410, and 412 are text data. Portions surrounded by dotted lines 402, 407, and 409 are image data. Portions surrounded by dotted lines 404 and 411 are graphic data. The image data is a configuration as an application example of resource data in the present exemplary embodiment.

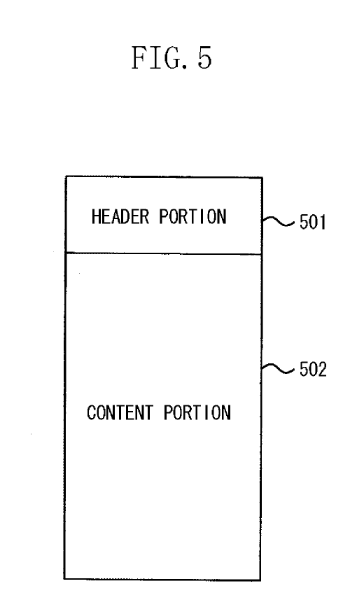

FIG. 5 is a view illustrating a configuration of an archive file which is in a storage format of a document used in the present exemplary embodiment. As illustrated in FIG. 5, the archive file includes a header section 501 and a content section 502. Data such as a file creation date, a creator, and a file size may be included in the header section 501. Not only text data, image data, and graphic data which configure a document but also rendering positions thereof, sizes thereof, and various types of metadata may be included in the content section 502. The printer device 203 can analyze the archive file illustrated in FIG. 5 to perform printing of the document illustrated in FIG. 3.

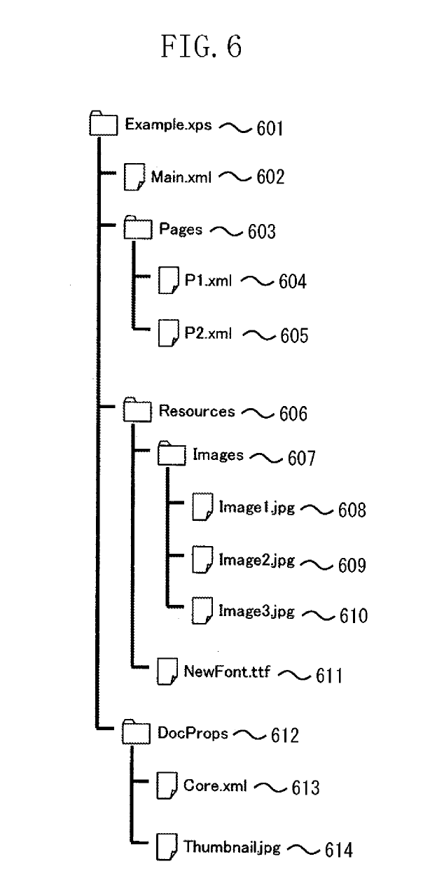

FIG. 6 is a view illustrating a configuration of data included in the content section 502 illustrated in FIG. 5. An example illustrated in FIG. 6 is a data configuration of the archive file of the document illustrated in FIG. 4. As illustrated in FIG. 6, the content section 502 has a tree structure including directories and files.

In FIG. 6, all of various files which configure a document are included in a tree belonging to a root directory 601 with a name of Examples.xps. Positions of various data files, which configure the document, in the tree structure or the number of pages of the document are described in XML format in an XML file 602 with a name of Main.xml. Link information to XML files 604 and 605, which will be described below, is also included in the XML file 602.

An XML file (a layout file) representing a rendering content (layout information) of each page is stored in a directory 603 with a name of Pages. A rendering content (layout information) of the first page of the document is described in XML format in an XML file 604 with a name of P1.xml. A rendering content of the second page of the document is described in XML format in an XML file 605 with a name of P2.xml. As the rendering contents described in the XML files 604 and 605, text data, graphic data, or arrangement information of image or text data is included. Link information to image data is also included in the XML files 604 and 605.

Since FIG. 6 illustrates an example of a configuration of the document illustrated in FIG. 4, the XML file 604 includes the text data 401, 403, and 405, the graphic data 404, and link information to the image data 402. Similarly, the XML file 605 includes the text data 406, 408, 410, and 412, the graphic data 411, and link information to the image data 407 and 409.

The XML files 604 and 605 also include information such as types of fonts for rendering the text data, font sizes, link information to a font file, and a rendering position of each data. The graphic data included in the XML files 604 and 605 is data described in a vector format.

Image data or font data necessary for rendering of the document is stored in a directory 606 with a name of Resources. Image data necessary for rendering of the document is stored in a directory 607 with a name of Images. An image file 608 with a name of Image1.jpg corresponds to the image data 402 illustrated in FIG. 4. Image files with names of Image2.jpg and Image3.jpg correspond to image data 407 and 409 illustrated in FIG. 4, respectively. Link information to the image file 608 is described in the XML file 604, and link information to the image files 609 and 610 is described in the XML file 605.

Glyph information of fonts used for rendering the text data stored in the XML files 604 and 605 is included in a font file NewFont.ttf. Link information to the font file 611 is described in the XML files 604 and 605. A font used here is an outline font.

Various types of metadata or a thumbnail image of the document is stored in a directory 612 with a name of DocProps. Various types of metadata such as a creation date, an edit date, and a creator of the document is stored in an XML file 613 with a name of Core.xml. An image file 614 with a name of Thumbnail.jpg is a thumbnail image in which a rendering result of the first page of the document is reduced.

As illustrated in FIG. 6, the archive file is generated by encapsulating the image files 608 to 610 or the layout files 604 and 605.

In the present exemplary embodiment, the archive file in which the file group of the configuration illustrated in FIG. 6 is included in the content section 502 is generated by the computer device 201 or the scanner device 204 and transmitted to the printer device 203. The configuration illustrated in FIG. 6 is an example, and XML files included in the directory 603 are increased or decreased as the number of pages of the document is increased or decreased. As the number of pieces of image data in the document is increased or decreased, image files included in the directory 607 are increased or decreased. As types of fonts required by the document are increased or decreased, font files included in the directory 606 are increased or decreased.

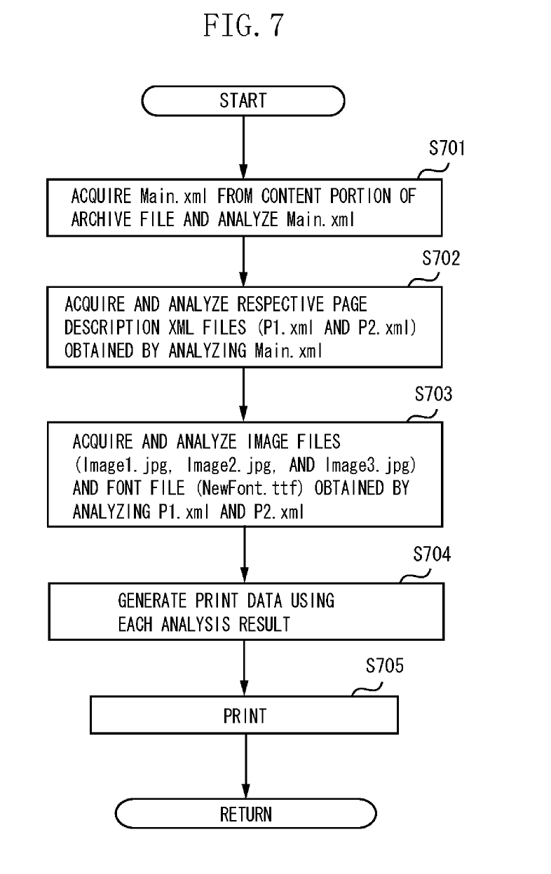

FIG. 7 is a flowchart illustrating a flow of processing for printing the archive file in which the configuration illustrated in FIG. 6 is included in the content section 502, using a printer device of a comparative example.

In step S701, the printer device of a comparative example acquires the XML file Main.xml 602 from the content section 502 of the archive file and analyzes the XML file Main.xml 602. Link information to an XML file describing rendering information of each page is described in the XML file Main.xml 602. Thus, in step S702, the printer device acquires the XML files (P1.xml 604 and P2.xml 605) from the content section 502 and analyzes the XML files.

In the XML files P1.xml 604 and P2.xml 605, link information to an image file or a font file is described. Thus, in step S703, the printer device acquires the image files (Image1.jpg 608, Image2.jpg 609, and Image3.jpg 610) and the font file (NewFont.ttf 611) from the content section 502 as needed and analyzes the image files and the font file.

Subsequently, in step S704, the printer device generates print data based on analysis results acquired by processing in steps S701 to S703. Then, in step S705, the printer device prints the print data.

As illustrated in FIG. 7, in a document format including a plurality of XML files and image files, it is commonly necessary to perform sequential processing starting with the first XML file. Typically, since the printer device performs printing in units of pages or in units of bands, processing in steps S702 to S705 is repeated. However, in the flowchart illustrated in FIG. 7, print data of all pages is generated by a one-time process for convenience of description.

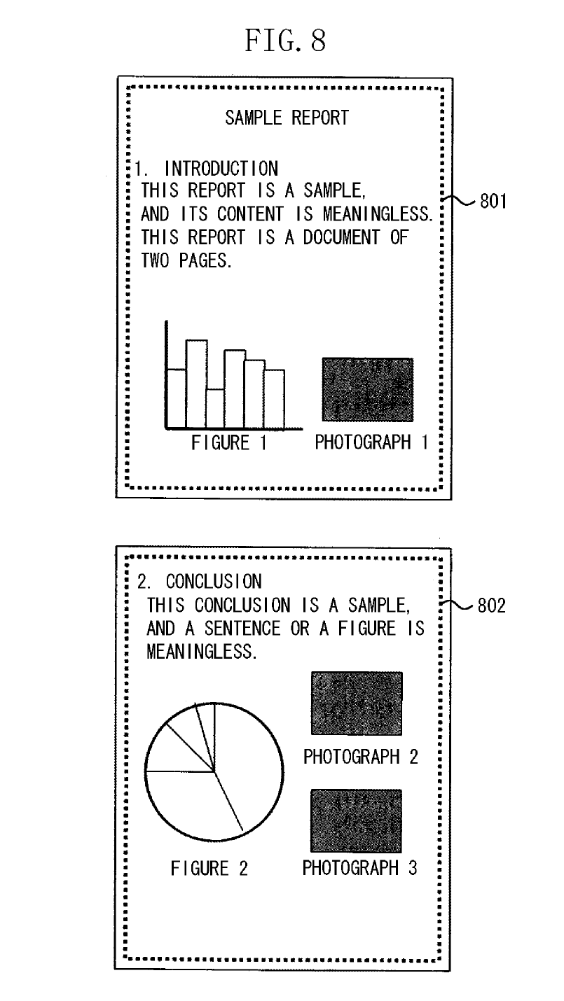

FIG. 8 is a view illustrating a rendering configuration of a document illustrated in FIG. 3. The configuration illustrated in FIG. 8 is different from the configuration illustrated in FIG. 4. In FIG. 8, areas surrounded by dotted lines 801 and 802 are configured as image data. In FIG. 8, the areas surrounded by dotted lines 801 and 802 are slightly smaller than the paper size, but the same size as the paper size may be used.

Since the document illustrated in FIG. 3 includes the text data or the graphic data, the configuration illustrated in FIG. 4 is appropriate for performing reediting. However, the configuration illustrated in FIG. 4 does not always need to be used to obtain the same printing result as in FIG. 3. As illustrated in FIG. 8, when image data of the same size as the paper size is present in each page, the same printing result as in FIG. 3 can be obtained.

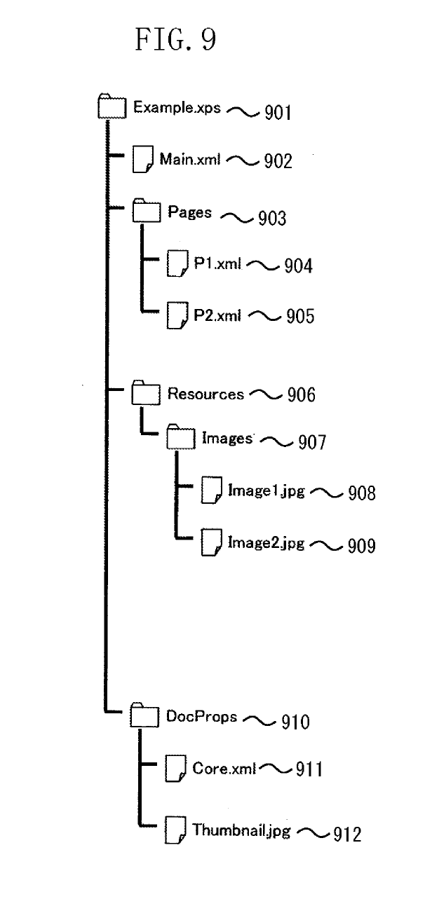

FIG. 9 is a view illustrating a configuration of data included in the content section 502 of the archive file of the document with the configuration illustrated in FIG. 8.

In FIG. 9, files or directories 901 to 909 are similar to the files or directories 601 to 609 illustrated in FIG. 6. Files or directories 910 to 912 are similar to the files or directories 612 to 614. Unlike the configuration illustrated in FIG. 6, in a configuration illustrated in FIG. 9, two image files are included in the Images directory 907. This is because in the case of the configuration illustrated in FIGS. 8 and 9, one image file is included in each page. Unlike FIG. 6, the font file is not included in the Resources directory 906. This is because in the case of the configuration illustrated in FIGS. 8 and 9, since a text portion is also expressed as image data, text data is not included, and font data is not necessary.

When the archive file of the document is generated with the configuration illustrated in FIGS. 8 and 9, since the configuration is simple, processing for generating print data can be performed at a higher speed compared to the comparative example as will be described below. Hereinafter, for the configuration illustrated in FIG. 6, a format of the configuration illustrated in FIG. 9 is referred to as a “simple document format”.

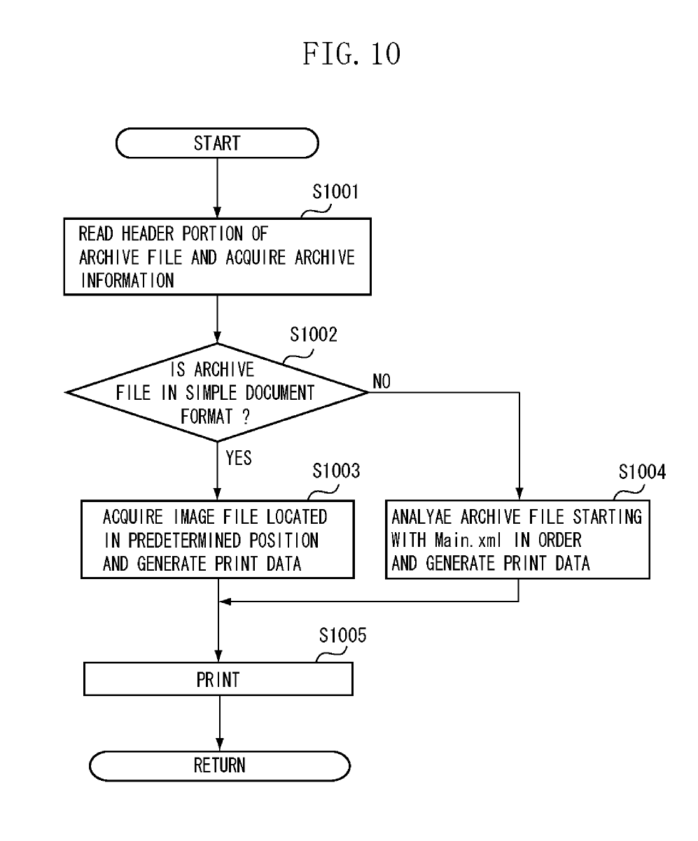

FIG. 10 is a flowchart illustrating a flow of processing for printing the archive file using the printer device 203 according to the first exemplary embodiment.

In step S1001, the printer device 203 reads the header section 501 of the archive file and acquires archive file information.

The archive file information includes information about whether the configuration of the content section 502 is in the simple document format, and then in step S1002, the printer device 203 determines the document format of the archive file based on the information.

When it is determined in step S1002 that the archive file is in the simple document format (YES in step S1002), then in step S1003, the printer device 203 does not perform analysis of the XML file, but acquires an image file in the Images directory 907 and generates print data. Thus, the printer device 203 generates the print data without using the layout information. On the other hand, when it is determined in step S1002 that the archive file is not in the simple document format (NO in step S1002), then in step S1004, the printer device analyzes the XML files starting with the XML file Main.xml 902 in order and generates print data. Thus, the printer device 203 generates the print data using the layout information. Processing in step S1004 is similar to processing insteps S701 to 5704 illustrated in FIG. 7.

Subsequently, in step S1005, the printer device 203 prints the printing date generated by processing in step S1003 or S1004.

Due to execution of processing illustrated in FIG. 10, processing of XML data is not necessary when the archive file in the simple document format is printed. Therefore, the printer device in which processing of image data is faster than processing of XML data can perform printing at a high speed.

In FIG. 10, when it is determined in step S1002 that the archive file is not in the simple document format, sequential analysis is performed starting with the XML file Main.xml 902 to generate print data. However, when it is determined in step S1002 that the archive file is not in the simple document format, printing may not be performed. In this case, types of printable documents are limited, but since XML processing is not necessary at all, the program size can be reduced. As a result, there are advantages of being capable of reducing the capacity of the ROM 102 or the RAM 103 and reducing the cost of the printer device.

In FIG. 10, the case in which information about whether the archive file is in the simple document format is included in the archive file information has been described as an example, but whether the archive file is in the simple document format may be determined based on generation source information included in the archive file information. In other words, it may be determined that the archive file generated by the computer device 201 is not in the simple document format and the archive file generated by the scanner device 204 is in the simple document format. In this case, the printer device 203 needs to retain information about the capability of a device connected thereto.

Information about whether the archive file is in the simple document format may not be included in the archive file information, but whether the archive file is in the simple document format may be determined based on information acquired from a transmission source of the archive file according to a communication protocol.

Next, a second exemplary embodiment of the invention will be described. In the second exemplary embodiment, similarly to the first exemplary embodiment described above, the printer device is described as an example. In the second exemplary embodiment, a printer configuration, a system configuration, and an archive file configuration are similar to the configurations of the first exemplary embodiment illustrated in FIGS. 1, 2, and 5.

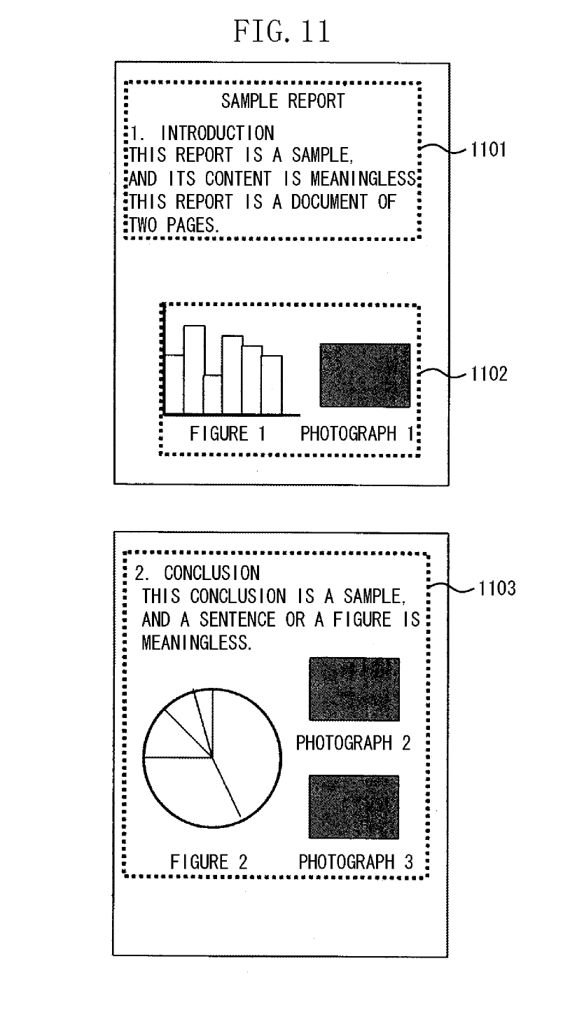

FIG. 11 is a view illustrating a rendering configuration of a document illustrated in FIG. 3 used in the second exemplary embodiment. The configuration illustrated in FIG. 11 is different from the configuration illustrated in FIG. 4 or 8. In FIG. 11, areas surrounded by dotted lines 1101 and 1102 are configured as image data. Similar to the configuration illustrated in FIG. 8, text data or graphic data is not present, but image data is present. The configuration illustrated in FIG. 11 differs from the configuration illustrated in FIG. 8 in size and number of pieces of image data. Due to such a configuration, a total of sizes of image data can be reduced. An area surrounded by dotted line 1103 illustrated in FIG. 11 is also configured as image data, and the area of the image data is narrower than the area surrounded by dotted line 802 illustrated in FIG. 8. When generating the archive file, the computer device 201 or the scanner device 204 automatically detects a white space and determines an appropriate image size and the number of pieces of image data.

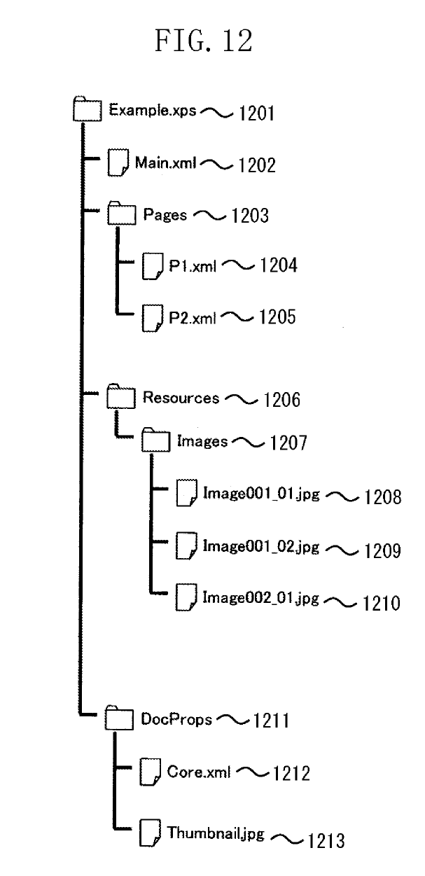

FIG. 12 is a view illustrating a configuration of data included in the content section 502 of the archive file of the document with the configuration illustrated in FIG. 11. In FIG. 12, files or directories 1201 to 1209 are similar to the files or directories 901 to 909 illustrated in FIG. 9, respectively. Files or directories 1211 to 1213 are similar to the files or directories 910 to 912, respectively. In the configuration view illustrated in FIG. 12, unlike the configuration illustrated in FIG. 9, three image files 1208 to 1210 are included in the Images directory 1207. Hereinafter, a format of the archive file with the configuration illustrated in FIGS. 11 and 12 is referred to as a “second simple document format”.

Even though not illustrated, among files illustrated in FIG. 12, a page number in which each image file in the Images directory 1207 is disposed and rendering position information of each image file are stored in an XML file Core.xml 1212.

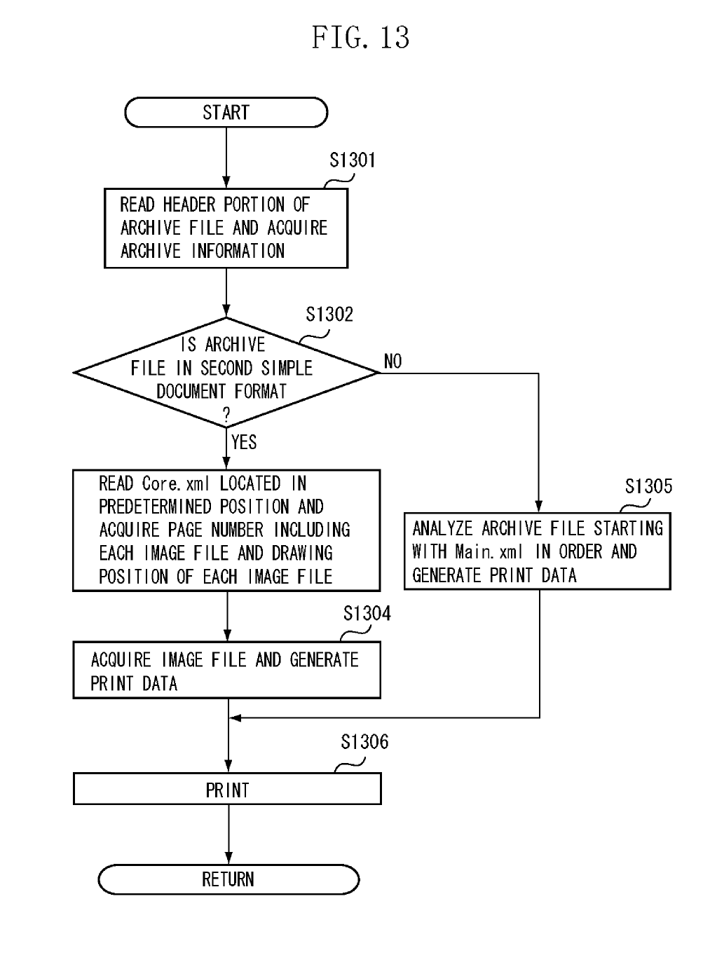

FIG. 13 is a flowchart illustrating a flow of processing for printing the archive file using the printer device 203 according to the second exemplary embodiment.

In step S1301, the printer device 203 reads the header section 501 of the archive file and acquires archive file information. Information about whether the configuration of the content section 502 is in the second simple document format is included in the archive file information, and then in step S1302, the printer device 203 determines the document format of the archive file based on the information.

When it is determined in step S1302 that the archive file is in the second simple document format (YES in step S1302), then in step S1303, the printer device 203 reads and analyzes the XML file Core.xml 1212. The printer device 203 acquires page number information in which each image file included in the archive file is disposed and rendering position information of each image file.

Subsequently, in step S1304, the printer device 203 acquires each image file present in the Image directory 1207 and generates print data based on the information acquired in step S1303.

On the other hand, when it is determined in step S1302 that the archive file is not in the second simple document format (NO in step S1302), then in step S1305, the printer device 203 analyzes the archive file starting with the XML file Main.xml 1202 in order and generates print data. Processing in step S1305 is similar to processing in steps S701 to 5704 illustrated in FIG. 7.

In step S1306, the printer device 203 prints the print data generated by processing in step S1304 or S1305.

In the present exemplary embodiment, page number information in which each image file is disposed and rendering position information of each image file are described in the XML file Core.xml 1212. The information may be described in the header section 501 of the archive file or a header section (not illustrated) of each image file instead of the XML file. The information may be included in a character string of a file name of each image file.

In the exemplary embodiments described above, printing by the printer device has been described as an example, but the present invention is not limited to the printer device but may be applied even when document data is displayed on a display device such as a television or an image viewer or a computer device with a rendering unit. In the exemplary embodiments described above, the case in which the archive file for printing is transmitted from the computer device 201 or the scanner device 204 to the printer device 203 has been described as an example. In addition, the exemplary embodiments may be applied even when the memory card including the archive file is inserted into the external storage device connection unit 109, and printing or displaying of the archive file present in the memory card is performed. In the exemplary embodiments described above, image data of Joint Photographic Experts Group (JPEG) format has been described as an example of resource data. The resource data is not limited to data of JPEG format but may include data of Portable Network Graphics (PNG) format or a bit map format or may be graphic data of vector format such as SVG.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-311295 filed Dec. 5, 2008, which is hereby incorporated by reference herein in its entirety.

What is claimed is:

1. An information processing apparatus comprising:
a determination unit configured to determine whether structured data including layout information and image information is in a predetermined format; and
a rendering unit configured to perform rendering of the image information without using the layout information when the determination unit determines that the structured data is in the predetermined format, and to perform rendering of the image information using the layout information when the determination unit determines that the structured data is not in the predetermined format.

2. The information processing apparatus according to claim 1, wherein the determination unit is configured to determine whether the structured data is in the predetermined format based on generation source information of the structured data.

3. The information processing apparatus according to claim 1, further comprising a printing unit configured to print image information rendered by the rendering unit.

4. The information processing apparatus according to claim 1, wherein the determination unit is configured to determine whether the structured data is in the predetermined format based on information of a header section of the structured data.

5. The information processing apparatus according to claim 1, wherein the image information includes an image file, and the layout information includes a layout file.

6. The information processing apparatus according to claim 5, wherein the layout file is described in Extensible Markup Language (XML) format.

7. The information processing apparatus according to claim 5, wherein the structured data is an archive file that is generated by encapsulating the image file and the layout file.

8. An information processing method comprising:
determining whether structured data including layout information and image information is in a predetermined format; and
performing rendering of the image information without using the layout information when it is determined that the structured data is in the predetermined format, and performing rendering of the image information using the layout information when it is determined that the structured data is not in the predetermined format.

9. A computer-readable storage medium storing a computer-executable program for causing a computer to perform an information processing method, the information processing method comprising:
determining whether structured data including layout information and image information is in a predetermined format; and
performing rendering of the image information without using the layout information when it is determined that the structured data is in the predetermined format, and performing rendering of the image information using the layout information when it is determined that the structured data is not in the predetermined format.
